(19) United States
(12) Patent Application Publication
(10) Pub. No.: US 2023/0055847 A1
(43) Pub. Date: Feb. 23, 2023

(54) SYSTEM AND METHOD FOR DYNAMICALLY GROUPING LEARNERS DURING A LIVE LEARNING SESSION

(71) Applicant: Vedantu Innovations Pvt. Ltd., Bangaluru (IN)

(72) Inventors: Pranav R. MALLAR, Bengaluru (IN); Pulkit JAIN, Bengaluru (IN)

(73) Assignee: Vedantu Innovations Pvt. Ltd., Bangaluru, Karnataka (IN)

(21) Appl. No.: 17/569,849

(22) Filed: Jan. 6, 2022

(30) Foreign Application Priority Data
Aug. 17, 2021 (IN) 202141037156

(51) Int. Cl. G09B 5/14; G09B 5/06; H04L 12/18

(52) U.S. Cl. CPC G09B 5/14; G09B 5/065; H04L 12/1822

(57) ABSTRACT

A system for dynamically grouping a plurality of learners during a live learning session delivered via an online learning platform is presented. The system includes a data module and a processor operatively coupled to the data module. The processor includes a feature generator, a parameter analyzer, a group optimizer, and a reassignment module. A related method is also presented.

### PRIORITY STATEMENT

The present application claims priority under 35 U.S.C. § 119 to Indian patent application number 202141037156 filed Aug. 17, 2021, the entire contents of which are hereby incorporated herein by reference.

### BACKGROUND

Embodiments of the present invention generally relate to systems and methods for grouping a plurality of learners during a live learning session delivered via an online learning platform, and more particularly to automated systems and methods for dynamically grouping a plurality of learners, using an AI model, during a live learning session delivered via an online learning platform.

Online learning systems represent a wide range of methods for the electronic delivery of information in an education or training setup. More specifically, interactive online learning systems are revolutionizing the way education is imparted. Such interactive online learning systems offer an alternate platform that is not only faster and potentially better but also bridges the accessibility and affordability barriers for the learners. Moreover, online learning systems provide learners with the flexibility of being in any geographic location while participating in the session.

Apart from providing convenience and flexibility, such online learning systems also ensure more effective and engaging interactions in a comfortable learning environment. With the advancement of technology, personalized interactive sessions are provided according to specific needs rather than just following a set pattern of delivering knowledge as prescribed by conventional educational institutions. Moreover, such a system allows a mobile learning environment where learning is not time-bound (anywhere-anytime learning).

However, online learning sessions typically include a large number of learners that are simultaneously learning via the online learning platform, thus posing challenges for the instructors delivering the learning session. Further, it may be difficult to engage meaningfully with other learners in such large groups.

The problem may be mitigated by creating random groups of learners assigned to corresponding instructor assistants before the start of the learning session. In such instances, the random grouping of the learners remains the same during the duration of the learning session or even for a series of such learning sessions. However, a random grouping of learners may pose problems such as mismatch in understanding levels as well as lack of diversity in the groups. Further, the random grouping doesn't allow for changes in group allocation, especially during a duration of a live learning session.

Thus, there is a need for automated systems and methods capable of dynamically grouping a plurality of learners during a live learning session.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a system for dynamically grouping a plurality of learners during a live learning session delivered via an online learning platform is presented. Each learner of the plurality of learners is assigned to a group of a set of groups for a duration of the live learning session. The system includes a data module and a processor operatively coupled to the data module. The data module is operatively coupled to the online learning platform and a plurality of computing devices used by the plurality of learners to engage in the live learning session. The data module is configured to access in-session data, post-session data, class data, and learner engagement data for the plurality of learners. The processor includes a feature generator, a parameter analyzer, a group optimizer, and a reassignment module. The feature generator is configured to generate a plurality of learner features based on the in-session data, the post-session data, and the class data. The parameter analyzer is configured to generate a plurality of group parameters for a set of groups to which the plurality of learners is currently assigned. The group optimizer is configured to dynamically reassign one or more learners of the plurality of learners to an optimized set of groups, based on an AI model, the plurality of learner features, the plurality of group parameters, and the learner engagement data. The reassignment module is configured to dynamically move the one or more learners of the plurality of learners to the corresponding reassigned groups, during the live learning session.

According to another example embodiment, a system for dynamically grouping a plurality of learners during a live learning session delivered via an online learning platform is presented. Each learner of the plurality of learners is assigned to a group of a set of groups for a duration of the live learning session. The system includes a memory storing one or more processor-executable routines and a processor cooperatively coupled to the memory. The processor configured to execute the one or more processor-executable routines to access in-session data, post-session data, class data, and learner engagement data for the plurality of learners, and generate a plurality of learner features based on the in-session data, the post-session data, and the class data. The processor is configured to execute the one or more processor-executable routines to generate a plurality of group parameters for a set of groups to which the plurality of learners is currently assigned. The processor is furthermore configured to execute the one or more processor-executable routines to dynamically reassign one or more learners of the plurality of learners to an optimized set of groups, based on an AI model, the plurality of learner features, the plurality of group parameters, and the learner engagement data. The processor is further configured to execute the one or more processor-executable routines to dynamically move the one or more learners of the plurality of learners to the corresponding reassigned groups, during the live learning session.

According to another example embodiment, a method for dynamically grouping a plurality of learners during a live learning session delivered via an online learning platform is presented. Each learner of the plurality of learners is assigned to a group of a set of groups for a duration of the live learning session. The method includes accessing in-session data, post-session data, class data, and learner engagement data for the plurality of learners, and generating a plurality of learner features based on the in-session data, the post-session data, and the class data. The method further includes generating a plurality of group parameters for a set of groups to which the plurality of learners is currently assigned. The method furthermore includes dynamically reassigning one or more learners of the plurality of learners to an optimized set of groups, based on an AI model, the plurality of learner features, the plurality of group parameters, and the learner engagement data. The method moreover includes dynamically moving the one or more learners of the plurality of learners to the corresponding reassigned groups, during the live learning session.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram illustrating an example online learning environment, according to some aspects of the present description,

FIG. 2 is a block diagram illustrating an example data module communicatively coupled to a plurality of learner computing devices, according to some aspects of the present description,

FIG. 3 is a block diagram illustrating an example data module communicatively coupled to a learner computing device, according to some aspects of the present description,

FIG. 4 is a block diagram illustrating an example system for dynamically grouping learners during a live learning session, according to some aspects of the present description,

FIG. 5A is a block diagram illustrating an example with dynamic regrouping of learners during a live learning session, according to some aspects of the present description,

FIG. 5B is a block diagram illustrating an example with dynamic regrouping of learners during a live learning session, according to some aspects of the present description,

FIG. 6 is a block diagram illustrating an example system for dynamically grouping learners during a live learning session, according to some aspects of the present description,

FIG. 7 is a flow chart illustrating an example method for dynamically grouping learners during a live learning session, according to some aspects of the present description, and

FIG. 8 is a block diagram illustrating an example computer system, according to some aspects of the present description.

### DETAILED DESCRIPTION OF EXAMPLE EMBODIMENTS

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently, or simultaneously. In addition, the order of operations may be re-arranged. The processes may be terminated when their operations are completed, but may also have additional steps not included in the figures. It should also be noted that in some alternative implementations, the functions/acts/steps noted may occur out of the order noted in the figures. For example, two figures shown in succession may, in fact, be executed substantially concurrently or may sometimes be executed in the reverse order, depending upon the functionality/acts involved.

Further, although the terms first, second, etc. may be used herein to describe various elements, components, regions, layers, and/or sections, it should be understood that these elements, components, regions, layers, and/or sections should not be limited by these terms. These terms are used only to distinguish one element, component, region, layer, or section from another region, layer, or a section. Thus, a first element, component, region, layer, or section discussed below could be termed a second element, component, region, layer, or section without departing from the scope of example embodiments.

Spatial and functional relationships between elements (for example, between modules) are described using various terms, including “connected,” “engaged,” “interfaced,” and “coupled.” Unless explicitly described as being “direct,” when a relationship between first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Example embodiments of the present description provide automated systems and methods for dynamically grouping a plurality of learners, using an AI model, during a live learning session delivered via an online learning platform.

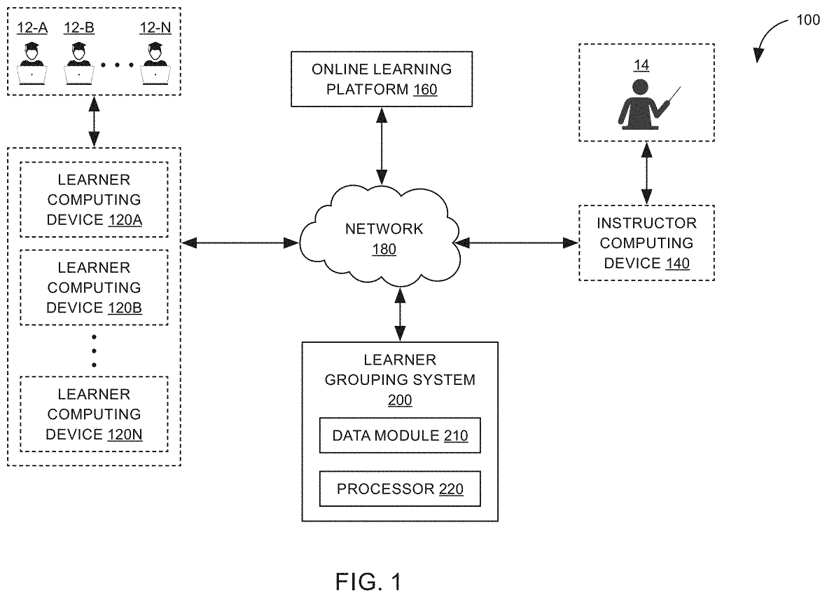

FIG. 1 illustrates an example online interactive learning environment 100 configured to provide a live learning session (which is hereafter simply referred to as the “learning session”), in accordance with some embodiments of the present description. The term “live learning session” as used herein refers to learning sessions delivered live i.e., in real-time (e.g., using at least live audio or video) via online learning platforms by the instructors, which allow for real-time interactions between the instructors and the learners. This is in contrast to pre-recorded learning sessions that are available on online learning platforms.

The online interactive learning environment includes a plurality of learners 12A, 12B . . . 12N (collectively represented by reference numeral 12) and one or more instructors 14 As used herein, the term “instructor” refers to an entity that is imparting information to the plurality of learners 12 during the learning session. It should be noted that although FIG. 1 shows one instructor for illustration purposes, the number of instructors may vary, and may depend on the learning requirements of the learning session. In some instances, the number of instructors may depend on the number of learners attending the learning session. The plurality of learners 12 may include more than 20 learners in some embodiments, more than 100 learners in some embodiments, and more than 500 learners in some other embodiments.

Non-limiting examples of such interactive sessions may include training programs, seminars, classroom sessions, and the like. In some embodiments, the instructor is a teacher, the learner is a student, and the interaction session is aimed at providing educational content. In such instances, the plurality of learners 12 may collectively constitute a class. As noted earlier, the plurality of learners 12 may be located at different geographical locations while engaging in the online interactive learning session and may belong to the same or different demographics.

The online learning environment 100 further includes a plurality of learner computing devices 120A, 120B . . . 120N. The learner computing devices are configured to facilitate the plurality of learners 12 to engage in the online learning session, according to aspects of the present technique. Non-limiting examples of learner computing devices include personal computers, tablets, smartphones, and the like. In the embodiment illustrated in FIG. 1, each learner computing device corresponds to a particular learner, e.g., learner computing device 120A corresponds to learner 12A, learner computing device 120B to learner 12B, and so on. Similarly, the online learning environment 100 further includes an instructor computing device 140. The instructor computing device 140 is configured to facilitate the instructor 14 to deliver the online learning session. Non-limiting examples of instructor computing devices include personal computers, tablets, smartphones, and the like.

The interactive online learning environment 100 further includes an online learning platform 160. The online learning platform 160 is used by the plurality of learners 12 to access the learning sessions and by the one or more instructors 14 to deliver the learning sessions. The learning sessions are delivered by the one or more instructors live (e.g., in a virtual live classroom) via the learning platform 160. The learning platform 160 may be accessed via a web page or via an app on the plurality of computing devices used by the plurality of learners 12. As described in detail later, the online learning platform 160 includes one or more interactive tools that facilitate interaction between the plurality of learners 12 or between the plurality of learners 12 and the one or more instructors 14, in real-time.

The various components of the online learning environment 100 may communicate through the network 180. In one embodiment, the network 180 uses standard communications technologies and/or protocols. Thus, the network 180 can include links using technologies such as Ethernet, 802.11, worldwide interoperability for microwave access (WiMAX), 3G, digital subscriber line (DSL), asynchronous transfer mode (ATM), InfiniBand, PCI Express Advanced Switching, etc. Similarly, the networking protocols used on the network 180 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc.

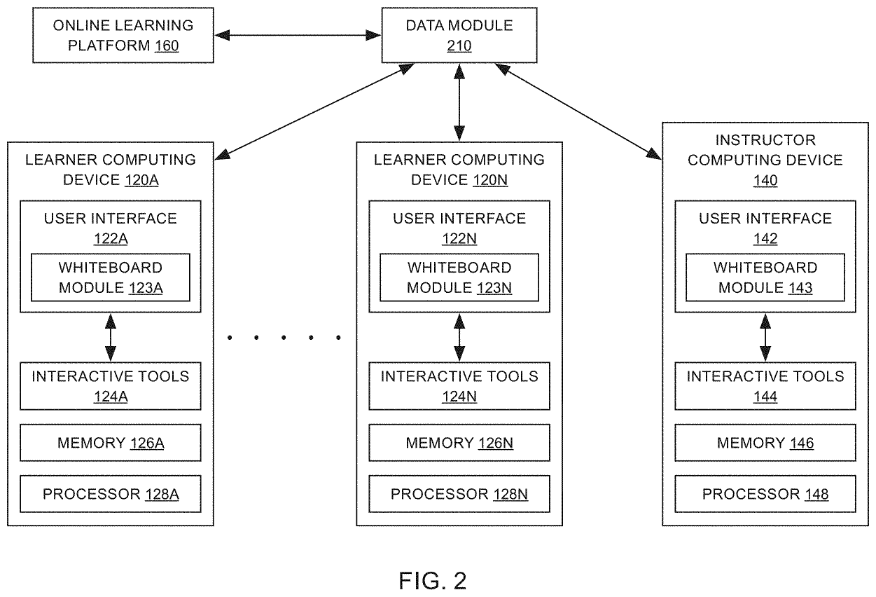

The online learning environment 100 further includes a learner grouping system 200 (hereinafter referred to as “system”) for dynamically grouping the plurality of learners 12 during a live learning session delivered via the online learning platform 160. The system 200 includes a data module 210 and a processor 220. Each of these components is described in detail below with reference to FIGS. 2-4.

The data module 210 is operatively coupled to the online learning platform 160 and a plurality of computing devices 120 used by the plurality of learners 12 to engage in the live learning session. The data module 210 is configured to access in-session data, post-session data, class data, and learner engagement data for the plurality of learners 12.

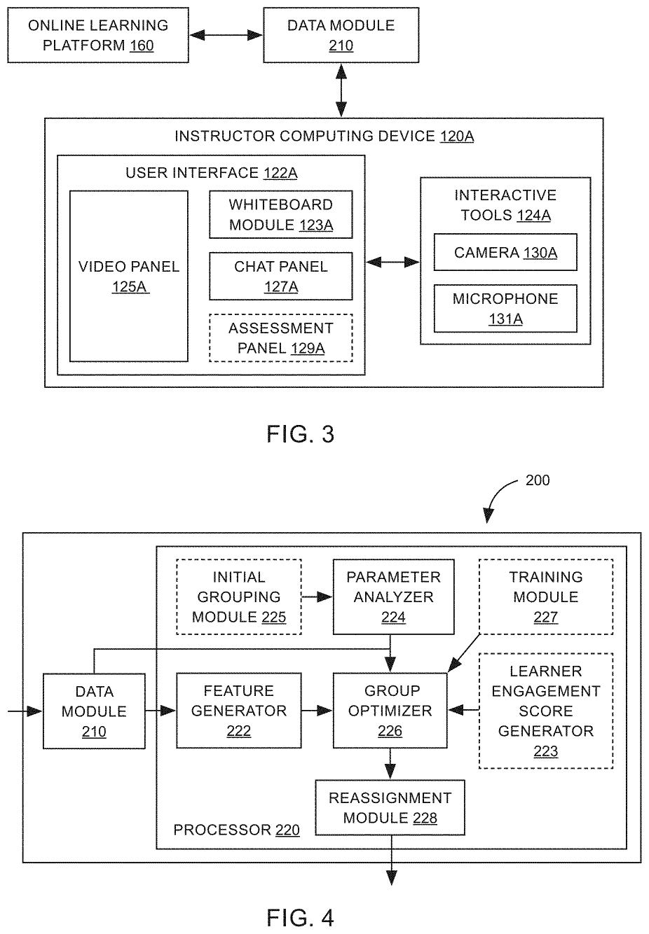

FIGS. 2 and 3 illustrate an example embodiment where the data module 210 is configured to access in-session data from the plurality of learners 12 and the learning platform 160. As shown in FIGS. 2 and 3, data module 210 is communicatively coupled to the plurality of computing devices 120A, 120B . . . 120N used by the plurality of learners 12 to engage in the online learning session. In some embodiments, the data module 210 may also be communicatively coupled to one or more computing devices 140 used by the one or more instructors 14 to deliver the online learning session (as shown in FIG. 2). The learner computing devices 120A . . . 120N include among other components, user interface 122A . . . 122N, interactive tools 124A . . . 124N, memory unit 126A . . . 126N, and processor 128A . . . 128N.

FIG. 3 illustrates a learner computing device 120A in more detail. The user interface 122A of the learner computing device 120A includes the whiteboard module 123A, a video panel 125A, a chat panel 127A, and an assessment panel 129A. Interactive tools 124A may include, for example, a camera 130A, and a microphone 131A, and are used to capture video, audio, and other inputs from the learner 12A.

Whiteboard module 123A is configured to enable the learners 12 and the one or more instructors 14 to communicate amongst each other by initiating an interaction session by submitting written content. Examples of written content include alpha-numeric text data, graphs, figures, scientific notations, gifs, and videos. The whiteboard module 123A may further include formatting tools that would enable each user to ‘write’ in the writing area. Examples of formatting tools may include a digital pen for writing, a text tool to type in the text, a color tool for changing colors, a shape tool used for generating figures and graphs. In addition, an upload button may be included in the whiteboard module 123A for uploading images of pre-written questions, graphs, conceptual diagrams, and other useful/relevant animation representations.

Video panel 125A is configured to display video signals of a selected set of participants of the learning session. In one embodiment, the video data of a participant (learner or instructor) that is speaking at a given instance is displayed on the video panel 125A. Chat panel 127A is configured to enable all participants to message each other during the course of the learning session. In one embodiment, the messages in the chat panel 127A are visible to all participants engaged in the learning session.

Assessment panel 129A is configured to enable a learner to engage in different in-session assessments (e.g., quizzes, hot spot-interactions, and the like) during the course of the learning session. In one embodiment, the inputs in the assessment panel 129A are visible to only the learner submitting the assessment (e.g, learner 12A in this instance). The interactive tools 124A may include a camera 130A for obtaining and transmitting video signals and a microphone 131A for obtaining audio input. In addition, the interactive tools 124A may also include a mouse, touchpad, keyboard, and the like.

As noted earlier, the data module 210 is configured to access in-session data for the plurality of learners 12. Non-limiting examples of in-session data include video data, messaging data, or in-session assessment data. In some embodiments, the data module 210 is configured to access in-session data in real-time for a live learning session.

The term “video data” as used herein refers to the video content recorded from the cameras of the corresponding computing devices as well as the data accessed by processing the video content such as emotion, attention levels, interest levels, and the like. Non-limiting examples of video data include emotion metrics, attentiveness scores, and the like. In one embodiment, the attentiveness score may be determined based on whether the learner is facing the learning platform/computing device or not. Further, the point of interest on a screen may be determined based on eye gaze detection.

The term “messaging data” as used herein refers to the messaging content recorded from the chat modules of the corresponding computing devices as well as the data accessed by processing the messaging content such as sentiment, attention levels, and the like. Non-limiting examples of messaging data include frequency of messages, the participant to whom the message is addressed (e.g., a learner or an instructor), sentiment of the message, peer involvement (i.e., involvement of other learners) with the message, intent classification of a message, or combinations thereof. An intent of a message may be classified, for example, based on the inputs provided by a learner in the message. Non-limiting examples of an intent may include positive or negative response to a method of delivering the learning session (e.g., whiteboard module, videos, and the like), positive or negative response to a pedagogy employed by the one or more instructors, or request for repetition of a particular topic or subject matter. In some embodiments, messaging data may further include a response from the instructor to a chat message by one or more learners and a response from the one or more learners regarding satisfaction level regarding the instructor's response.

The term “in-session assessment data” as used herein refers to the data captured based on interactions such as quizzes, in-session prompts/questions, hotspot interactions, and the like. Non-limiting examples of in-session assessment data include in-session quiz metrics, responses to in-session close-ended questions, hotspot interaction metrics, or combinations thereof. The term “in-session quiz” as used herein refers to in-session assessments/tests that are administered during a learning session itself. Non-limiting examples of quiz metrics include the number of attempts, time to answer, level of questions answered, accuracy, and the like. In some embodiments, the in-session quizzes are administered by the in-session assessment panel. The close-ended questions may be answered by the learners via audio, in-session assessment panel, and the like.

In-session assessment data may also be measured by initiating a variety of interactions between the learners and the online learning platform/instructors. For example, along with conventional in-session quizzes, the online learning platform 160 may also enable other means of student assessment using one or more gamification techniques. In some embodiments, hotspots may be used to engage and assess the learners during a learning session. The term “hotspot” as used herein refers to a visible location on a screen that is linked to perform a specified task. Non-limiting examples of hotspot interactions may include selecting/matching a set of images, filling in the blanks, etc.

As noted earlier, the data module 210 is further configured to access the post-session data for the plurality of learners 12. Non-limiting examples of post-session data include feedback survey data, post-session assessment data, post-session doubts data, or combinations thereof.

Feedback survey data includes data from feedback surveys submitted by a learner after completing the one or more learning sessions. In some embodiments, the feedback survey data may be submitted by the learner on the online learning platform 160 after the one or more learning sessions are completed.

The term “post-session assessment data” as used herein refers to data obtained from post-session tests and/or assignments completed by a learner after attending one or more learning sessions. Non-limiting examples of test metrics include the total number of tests given, total number of tests taken, total number of questions attempted, accuracy of the attempted questions, total number of incorrect questions, type of mistakes, time spent on accurate answers, time spent on inaccurate answers, levels of questions answered, total number of assignments given, total number of assignments taken, accuracy on the assignments, and the like.

The term “post-session doubt data” as used herein refers to any data related to doubts submitted by a learner for a particular learning session after the learning session and/or a post-session assessment related to the session is completed. Non-limiting examples of post-session doubt data may include frequency of doubts submitted, number of doubts resolved, feedback associated with doubts resolution, the type and/or level of questions raised in the doubts, time between the learning session/test, and doubt submission, or combinations thereof. The post-session doubt data may be further tagged by metadata such as topic, content, learner ID, instructor ID, and the like.

The data module 210 is further configured to access the class data for a plurality of learners. Non-limiting examples of class data include demographic data, overall academic performance data, historical subject-based assessment data, historical subject-based assignment data, historical in-session activity data, or combinations thereof.

Non-limiting examples of demographic data include school category, school tier, school location, grade level, learning goal, or combinations thereof. The term “learning goal” as used herein refers to a target outcome desired from the learning session. Non-limiting examples of learning goals may include: studying for a particular grade (e.g., grade VI^{th}, grade X^{th}, grade XII^{th}, and the like), tuitions related to a particular grade, qualifying for a specific entrance exam (e.g, JEE, NEET, GRE, GMAT, SAT, LSAT, MCAT, etc.), or competing in national/international competitive examinations (e.g., Olympiads).

Overall academic performance data may be generated using time series analysis and the learners may be classified based on the percentiles. Historical subject-based assessment and historical subject-based assignment data are generated using time series analysis based on post-session tests and/or assignments completed by a learner for a particular subject and/or a set of subjects. Non-limiting examples of test and assignment metrics include total number of tests given, total number of tests taken, total number of questions attempted, accuracy of the attempted questions, total number of incorrect questions, type of mistakes, time spent on accurate answers, time spent on inaccurate answers, levels of questions answered, total number of assignments given, total number of assignments taken, accuracy on the assignments, and the like. Historical in-session activity data is estimated based on time-series analysis of in-session data for multiple learning sessions.

The term “learner engagement data” as used herein refers to a learner metric that measures, in real-time, the engagement level of each learner of the plurality of learners attending the live learning session. In some embodiments, the learner metric may correspond to a learner engagement score generated in real-time during the live learning session using an AI model. As described in detail later, the learner engagement score of each learner of the plurality of learners is used to optimize the AI model used to assign the plurality of learners to an optimized set of groups.

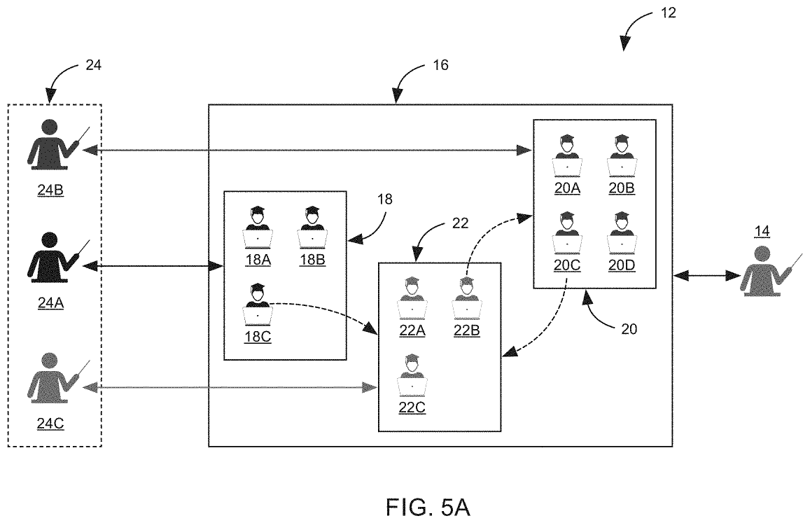

As noted earlier, the system 200 further includes a processor 220 coupled to the data module 210. FIG. 4 illustrates an example learner grouping system 200 including the data module 210 and the processor 220. The processor 220 includes a feature generator 222, a parameter analyzer 224, a group optimizer 226, and a reassignment module 228. Each of these components is further described in detail below.

The feature generator 222 is configured to generate a plurality of learner features based on the in-session data, the post-session data, and the class data. In some embodiments, the feature generator 222 is configured to generate a plurality of in-session features based on the in-session data; a plurality of post-session features based on the post-session data, and a plurality of class features based on the class data. The plurality of learner features may be generated using one or more AI models.

As noted earlier, the data module 210 is further configured to access learner engagement data. The learner engagement data include an individual learner engagement score for each learner of the plurality of learners 12 measured in real-time. In some embodiments, the learner engagement data may be generated separately and presented to the data module 210 in real-time.

In some other embodiments, the system 200 may further include a learner engagement score generator 223, as shown in FIG. 4, configured to generate an engagement score for each learner of the plurality of learners in real-time during the live learning session. The engagement score generator 223 is configured to generate, in-real-time, from a trained AI model (different from the AI model used by the group optimizer), individual learner engagement scores for a live learning session based on real-time in-session features generated from real-time in-session data for the live learning session. Non-limiting examples of real-time in-session data used to generate the learner engagement score include whiteboard data, audio data, video data, messaging data, browsing data, or in-session assessment data, and the like. The learner engagement score data generated, in-real-time, by the engagement score generator 223 is further presented to the group optimizer 226, as described in detail below.

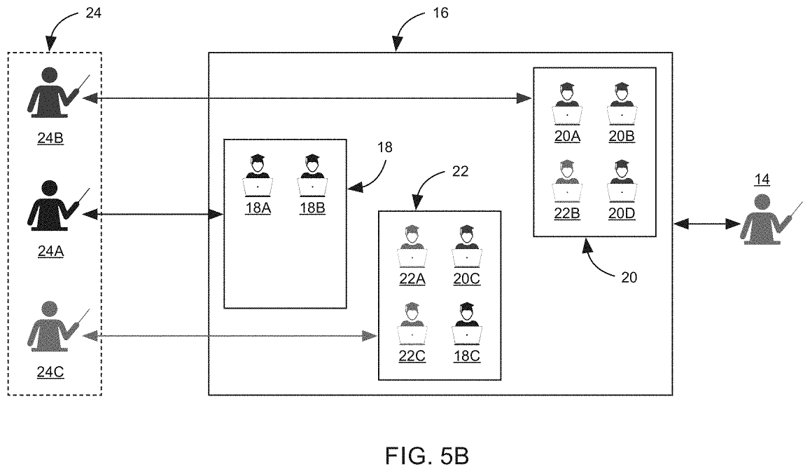

As mentioned earlier, during a live learning session, the plurality of learners is divided into a set of groups. This is further illustrated in FIG. 5A, where the plurality of learners 12 is assigned to a set of groups 16. It should be noted that the set of groups 16 includes three groups (i.e., groups 18, 20, and 21) for illustration purposes only and the number of groups within the set of groups 16 may vary depending on the number of learners in the plurality of learners 12, number of instructor assistants available, and so on. The set of groups 16, as shown in FIG. 5A, may be an initial set of groups to which the plurality of learners 12 is assigned or maybe a set of groups generated during a duration of the live learning session, using the systems and methods presented herein.

As shown in FIG. 5A, each group within the set of groups 16 further includes a plurality of learners assigned to each group. By way of example, the group 18 includes learners 18A-18C, the group 20 includes learners 20A-20C, and the group 22 includes learners 22A-22C. It should be noted that the number of learners in each group of the set of groups 16 may be the same or different. Further, the number of learners in each group of the set of groups may vary during a duration of the live learning session as the learners are dynamically reassigned during the live learning session.

As noted earlier, the interactive learning environment 100 further includes one or more instructors 14 delivering the live learning session. In some embodiments, the online learning environment 100 may further include a group of instructor assistants 24 facilitating the delivery of the live learning session. Each learner group of the set of groups 16 is further assigned to an instructor assistant, as shown in FIG. 5A. For example, in FIG. 5A, learner group 18 is assigned to instructor assistant 24A, learner group 20 is assigned to instructor assistant 24B, and learner group 22 is assigned to instructor assistant 24C.

The group of instructor assistants 24 may facilitate individual learner interactions either during the live learning session (e.g., responding to in-session messages, reviewing in-session assessments, etc.) or after the learning session (e.g., responding to post-session doubts data, reviewing post-session assessments, etc.). In some embodiments, the instructor assistants may be further grouped based on one or more instructor parameters.

In some embodiments, an instructor assistant 24 of the group of instructor assistants may be assigned to a particular learner group based at least in part on one or more of learner parameters and instructor parameters estimated based on historical data. Non-limiting examples of learner group parameters and instructor group parameters include learner engagement scores, learner demographics, learner performance metrics, learner-instructor assistant rapport metrics and the like.

In some embodiments, as shown in FIG. 4, the processor 220 further includes an initial grouping module 225 configured to assign the plurality of learners 12 to an initial set of groups before the start of the live learning session. The initial grouping module 225 may be configured to group the plurality of learners based on: (i) an initial AI model and historical data for the plurality of learners (if available), or (ii) a random allocation.

Referring again to FIG. 4, the parameter analyzer 224 is configured to generate a plurality of group parameters for a set of groups to which the plurality of learners 12 is currently assigned. In some embodiments, the parameter analyzer 224 is configured to generate a plurality of group parameters for each group of the set of groups 16 in real-time.

The plurality of learner features generated by the feature generator 222, the plurality of group parameters generated by the parameter analyzer 224, and the learner engagement data accessed in real-time by the data module 210 are presented to the group optimizer 226, as shown in FIG. 4. The plurality of learner features measured in real-time, the plurality of group parameters generated in real-time, along with the real-time learner engagement data are further stored in a database (not shown in FIGs.)

The group optimizer 226 is configured to dynamically reassign one or more learners of the plurality of learners 12 to an optimized set of groups, based on an AI model, the plurality of learner features, the plurality of group parameters, and the learner engagement data. The AI model is trained to find the right mix of learners from different groups to which they are currently assigned such that they complement each other's learning. Thus, the learners are assigned to a group that functions as the optimized group for the learners to improve themselves. Non-limiting examples of suitable AI models include long short-term memory networks, convolutional neural networks, or a combination thereof.

In some embodiments, the group optimizer 226 is configured to optimize an output of the AI model based on an estimated change in learner engagement data, when reassigning learners of the plurality of learners to the optimized set of groups. The group optimizer 226 uses the learner features and the group parameters to model the best fit group using the AI model. The output is then measured with the delta created in a learner engagement score for each learner of the plurality of learners 12 between different group permutations. The AI model further self-corrects to optimize on increasing the individual learner engagement scores.

In some embodiments, the processor 220 may further include a training module 227 configured to train the AI model based on the learner engagement data, as described herein earlier. In some embodiments, all the past data from the plurality of learners 12 is stored and used to train the AI model. The training module 227 may be further configured to train the AI model based on or more additional suitable data, not described herein. In some embodiments, the training module 227 is configured to train the AI model at defined intervals, e.g., weekly, bi-weekly, fortnightly, monthly, etc. In some other embodiments, the training module 227 is configured to train the AI model continuously in a dynamic manner. The training module is further configured to present the trained AI model to the group optimizer 226, as shown in FIG. 4.

Referring again to FIG. 4, the processor further includes a reassignment module 228 configured to dynamically move the one or more learners of the plurality of learners 12 to the corresponding reassigned groups, during the live learning session. The details of the groups to which the one or more learners of the plurality of learners 12 are reassigned may be presented by the grouping module 226 to the reassignment module 228, which in turn may then dynamically move the one or more learners to the reassigned group.

This is further illustrated by way of examples in FIGS. 5A and 5B. In the example shown in FIG. 5A, the grouping module reassigns learner 18C from group 18 to group 22, learner 20C from group 20 to group 22, and learner 22B from group 22 to group 20. The learners 18C, 20C, and 22B are moved to their reassigned groups by the reassignment module 228, as shown in FIG. 5B, thus resulting in a new group configuration.

As mentioned earlier, the system 200 is configured to keep monitoring the learner groups and dynamically reassign the learners to a suitable group during the entire duration of the live learning session. For example, if a learner engagement score for one or more learners falls below a threshold value, the system 200 may dynamically reassign the one or more learners to a new learner group.

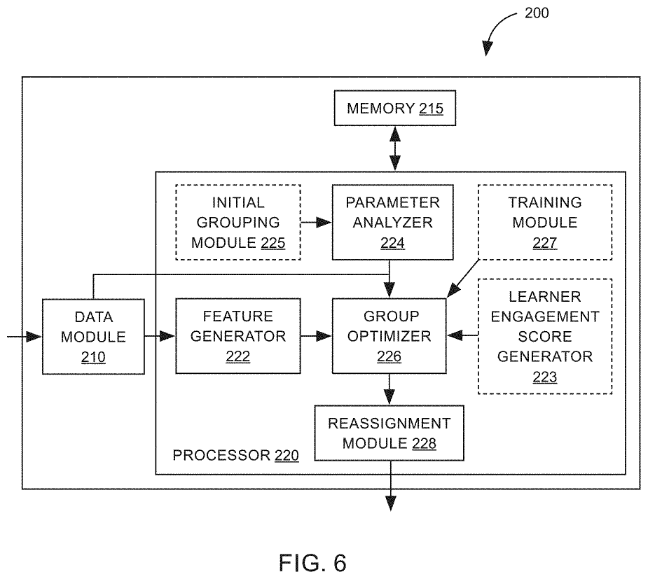

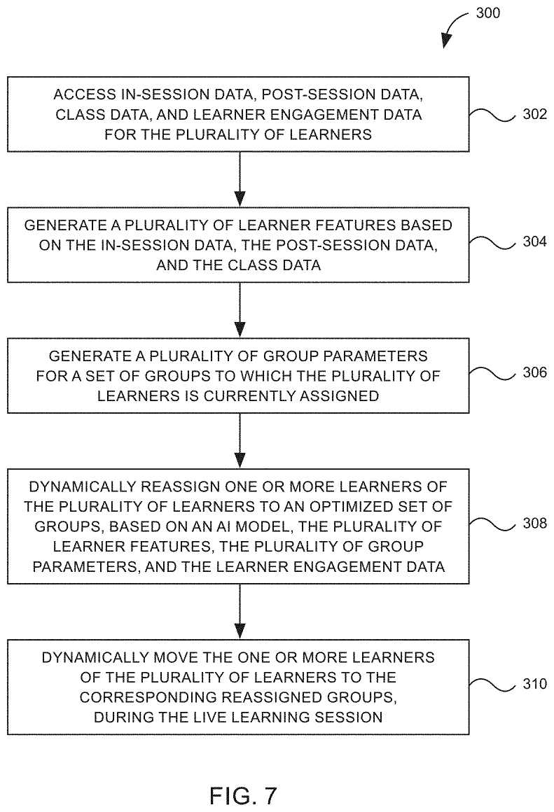

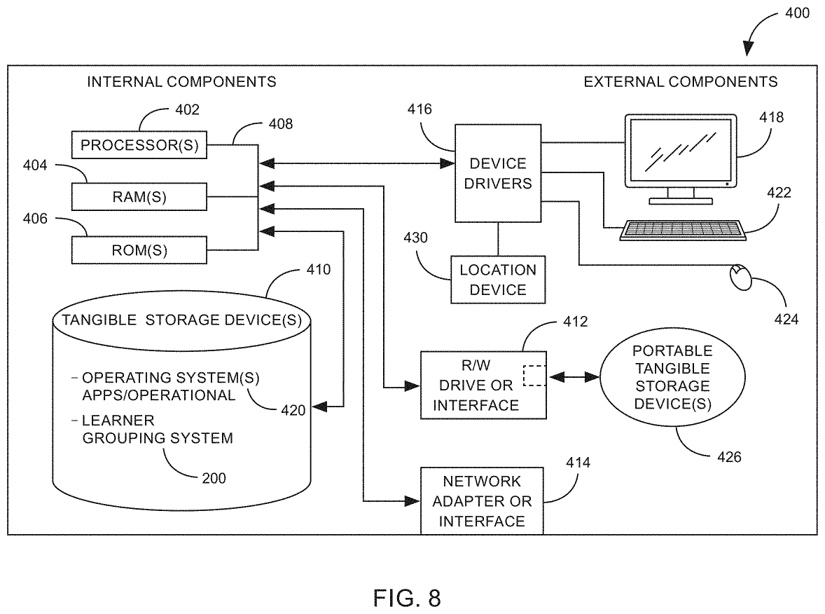

Referring now to FIG. 6, a learner grouping system 200 in accordance with some embodiments of the present description is illustrated. The system 200 includes a data module 210, a memory 215 storing one or more processor-executable routines and a processor 220 communicatively coupled to the memory 215. The processor 220 includes a feature generator 222, a parameter analyzer 224, a group optimizer 226, and a reassignment module 228. Each of these components is further described in detail earlier with reference to FIG. 4. The processor 220 is configured to execute the processor-executable routines to perform the steps illustrated in the flow chart of FIG. 7.

FIG. 7 is a flowchart illustrating a method 300 for dynamically grouping a plurality of learners during a live learning session delivered via an online learning platform is presented. Each learner of the plurality of learners is assigned to a group of a set of groups for a duration of the live learning session. The method 300 may be implemented using the systems of FIGS. 4 and 6, according to some aspects of the present description. Each step of the method 300 is described in detail below.

At step 302, the method 300 includes accessing in-session data, post-session data, class data, and learner engagement data for the plurality of learners. Definitions and examples of in-session data, post-session data, class data, and learner engagement data are provided herein earlier. The method may further include, as described herein earlier, generating learner engagement for the plurality of learners in real-time.

At step 304, the method 300 includes generating a plurality of learner features based on the in-session data, the post-session data, and the class data. The method 300, further includes, at step 306, generating a plurality of group parameters for a set of groups to which the plurality of learners is currently assigned.

In some embodiments, the method 300 may further include (not shown in FIGs.) assigning the plurality of learners to an initial set of groups before the start of the live learning session based on: (i) an initial AI model and historical data for the plurality of learners, or (ii) a random allocation.

At step 308, the method 300 includes dynamically reassigning one or more learners of the plurality of learners to an optimized set of groups, based on an AI model, the plurality of learner features, the plurality of group parameters, and the learner engagement data. In some embodiments, the method 300 includes optimizing an output of the AI model based on an estimated change in learner engagement data, when reassigning one or more learners of the plurality of learners to the optimized set of groups.

At step 308, the method 300 further includes modeling the best fit group using the AI model, the learner features, and the group parameters. The output is then measured with the delta created in a learner engagement score for each learner of the plurality of learners between different group permutations. The AI model further self-corrects to optimize on increasing the individual learner engagement scores.

The AI model may be trained to find the right mix of learners from different groups to which they are currently assigned such that they complement each other's learning. Thus, the learners are assigned to a group that functions as the optimized group for the learners to improve themselves. Non-limiting examples of suitable AI models include long short-term memory networks, convolutional neural networks, or a combination thereof.

The method 300 further includes, at step 310, dynamically moving the one or more learners of the plurality of learners to the corresponding reassigned groups, during the live learning session.

Thus, according to the systems and methods described herein, at the beginning of a live session, each learner is assigned to a default group of the set of groups (e.g., using the initial grouping module). As the live learning session progresses and the learner grouping system starts accumulating data about the learner interactions and the learner engagement in the learning session, the system and methods described herein facilitate the dynamic reallocation of the learner to other groups in a seamless way. According to some embodiments, the dynamic grouping of the learners may facilitate better peer matching at the level of understanding of the learners in each group. This enables the learners to interact with groups that are more collaborative and beneficial to the learning of a particular learner.

Further, during the live learning session, if a learner's engagement score falls below a threshold value, the systems and methods described herein dynamically reallocate the learner to a different group. Furthermore, the dynamic grouping of the learners during the live learning session enables the instructor assistants to better engage with the learners in their respective groups as the group consists of learners with similar learning profiles. Thus, enabling the learning environment to provide more personalized learning to the learners of a particular group that is more relevant to the level that they are in the learning session.

The systems and methods described herein may be partially or fully implemented by a special purpose computer system created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium, such that when run on a computing device, cause the computing device to perform any one of the aforementioned methods. The medium also includes, alone or in combination with the program instructions, data files, data structures, and the like. Non-limiting examples of the non-transitory computer-readable medium include, but are not limited to, rewriteable non-volatile memory devices (including, for example, flash memory devices, erasable programmable read-only memory devices, or a mask read-only memory devices), volatile memory devices (including, for example, static random access memory devices or a dynamic random access memory devices), magnetic storage media (including, for example, an analog or digital magnetic tape or a hard disk drive), and optical storage media (including, for example, a CD, a DVD, or a Blu-ray Disc). Examples of the media with a built-in rewriteable non-volatile memory, include but are not limited to memory cards, and media with a built-in ROM, including but not limited to ROM cassettes, etc. Program instructions include both machine codes, such as those produced by a compiler, and higher-level codes that may be executed by the computer using an interpreter. The described hardware devices may be configured to execute one or more software modules to perform the operations of the above-described example embodiments of the description, or vice versa.

Non-limiting examples of computing devices include a processor, a controller, an arithmetic logic unit (ALU), a digital signal processor, a microcomputer, a field programmable array (FPA), a programmable logic unit (PLU), a microprocessor, or any device which may execute instructions and respond. A central processing unit may implement an operating system (OS) or one or more software applications running on the OS. Further, the processing unit may access, store, manipulate, process, and generate data in response to the execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

One example of a computing system 400 is described below in FIG. 10. The computing system 400 includes one or more processor 402, one or more computer-readable RAMs 404, and one or more computer-readable ROMs 404 on one or more buses 408. Further, the computer system 408 includes a tangible storage device 410 that may be used to execute operating systems 420 and the learner grouping system 200. Both, the operating system 420 and the learner grouping system 200 are executed by processor 402 via one or more respective RAMs 404 (which typically includes cache memory). The execution of the operating system 420 and/or learner grouping system 200 by the processor 402, configures the processor 402 as a special-purpose processor configured to carry out the functionalities of the operation system 420 and/or the learner grouping system 200, as described above.

Examples of storage devices 410 include semiconductor storage devices such as ROM 506, EPROM, flash memory or any other computer-readable tangible storage device that may store a computer program and digital information.

Computing system 400 also includes a R/W drive or interface 412 to read from and write to one or more portable computer-readable tangible storage devices 426 such as a CD-ROM, DVD, memory stick or semiconductor storage device. Further, network adapters or interfaces 414 such as a TCP/IP adapter cards, wireless Wi-Fi interface cards, or 3G or 4G wireless interface cards or other wired or wireless communication links are also included in the computing system 400.

In one example embodiment, the learner grouping system 200 may be stored in tangible storage device 410 and may be downloaded from an external computer via a network (for example, the Internet, a local area network or another wide area network) and network adapter or interface 414.

Computing system 400 further includes device drivers 416 to interface with input and output devices. The input and output devices may include a computer display monitor 418, a keyboard 422, a keypad, a touch screen, a computer mouse 424, and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

While only certain features of several embodiments have been illustrated and described herein, many modifications and changes will occur to those skilled in the art. It is, therefore, to be understood that the appended claims are intended to cover all such modifications and changes as fall within the scope of the invention and the appended claims.

1. A system for dynamically grouping a plurality of learners during a live learning session delivered via an online learning platform, wherein each learner of the plurality of learners is assigned to a group of a set of groups for a duration of the live learning session, the system comprising:
a data module operatively coupled to the online learning platform and a plurality of computing devices used by the plurality of learners to engage in the live learning session, the data module configured to access in-session data, post-session data, class data, and learner engagement data for the plurality of learners; and
a processor operatively coupled to the data module, the processor comprising:
a feature generator configured to generate a plurality of learner features based on the in-session data, the post-session data, and the class data;
a parameter analyzer configured to generate a plurality of group parameters for a set of groups to which the plurality of learners is currently assigned;
a group optimizer configured to dynamically reassign one or more learners of the plurality of learners to an optimized set of groups, based on an AI model, the plurality of learner features, the plurality of group parameters, and the learner engagement data; and
a reassignment module configured to dynamically move the one or more learners of the plurality of learners to the corresponding reassigned groups, during the live learning session.

2. The system of claim 1, wherein the group optimizer is configured to optimize an output of the AI model based on an estimated change in learner engagement data when reassigning one or more learners of the plurality of learners to the optimized set of groups.

3. The system of claim 1, wherein the in-session data comprises one or more of video data, messaging data, or in-session assessment data for the plurality of learners.

4. The system of claim 1, wherein the post-session data comprises one or more of feedback survey data, post-session assessment data, or post-session doubts data for the plurality of learners.

5. The system of claim 1, wherein the class data comprises one or more of: demographic data, overall academic performance data, historical subject-based assessment data, historical subject-based assignment data, or historical in-session activity data for the plurality of learners.

6. The system of claim 1, wherein the processor further comprises an initial grouping module configured to assign the plurality of learners to an initial set of groups before the start of the live learning session based on: (i) an initial AI model and historical data for the plurality of learners, or (ii) a random allocation.

7. The system of claim 1, wherein the system further comprises a learner engagement score generator configured to generate an engagement score for each learner of the plurality of learners in real-time during the live learning session.

8. The system of claim 1, wherein the processor further comprises a training module configured to train the AI model based on the learner engagement data.

9. A system for dynamically grouping a plurality of learners during a live learning session delivered via an online learning platform, wherein each learner of the plurality of learners is assigned to a group of a set of groups for a duration of the live learning session, the system comprising:
a memory storing one or more processor-executable routines; and
a processor cooperatively coupled to the memory, the processor configured to execute the one or more processor-executable routines to:
access in-session data, post-session data, class data, and learner engagement data for the plurality of learners;
generate a plurality of learner features based on the in-session data, the post-session data, and the class data;
generate a plurality of group parameters for a set of groups to which the plurality of learners is currently assigned;
dynamically reassign one or more learners of the plurality of learners to an optimized set of groups, based on an AI model, the plurality of learner features, the plurality of group parameters, and the learner engagement data; and
dynamically move the one or more learners of the plurality of learners to the corresponding reassigned groups, during the live learning session.

10. The system of claim 9, wherein the processor is further configured to execute the one or more processor-executable routines to optimize an output of the AI model based on an estimated change in learner engagement data when reassigning the one or more learners of the plurality of learners to the optimized set of groups.

11. The system of claim 9, wherein the processor is further configured to execute the one or more processor-executable routines to assign the plurality of learners to an initial set of groups before the start of the live learning session based on: (i) an initial AI model and historical data for the plurality of learners, or (ii) a random allocation.

12. The system of claim 9, wherein the processor is further configured to execute the one or more processor-executable routines to generate an engagement score for each learner of the plurality of learners in real-time during the live learning session.

13. The system of claim 9, wherein the processor is further configured to execute the one or more processor-executable routines to train the AI model based on the learner engagement data.

14. A method for dynamically grouping a plurality of learners during a live learning session delivered via an online learning platform, wherein each learner of the plurality of learners is assigned to a group of a set of groups for a duration of the live learning session, the method comprising:
accessing in-session data, post-session data, class data, and learner engagement data for the plurality of learners;
generating a plurality of learner features based on the in-session data, the post-session data, and the class data;
generating a plurality of group parameters for a set of groups to which the plurality of learners is currently assigned;
dynamically reassigning one or more learners of the plurality of learners to an optimized set of groups, based on an AI model, the plurality of learner features, the plurality of group parameters, and the learner engagement data; and
dynamically moving the one or more learners of the plurality of learners to the corresponding reassigned groups, during the live learning session.

15. The method of claim 14, further comprising optimizing an output of the AI model based on an estimated change in learner engagement data, when reassigning one or more learners of the plurality of learners to the optimized set of groups.

16. The method of claim 14, wherein the in-session data comprises one or more of video data, messaging data, or in-session assessment data for the plurality of learners.

17. The method of claim 14, wherein the post-session data comprises one or more of feedback survey data, post-session assessment data, or post-session doubts data for the plurality of learners.

18. The method of claim 14, wherein the class data comprises one or more of: demographic data, overall academic performance data, historical subject-based assessment data, historical subject-based assignment data, or historical in-session activity data for the plurality of learners.

19. The method of claim 14, further comprising assigning the plurality of learners to an initial set of groups before the start of the live learning session based on: (i) an initial AI model and historical data for the plurality of learners, or (ii) a random allocation.

20. The method of claim 14, further comprising generating an engagement score for each learner of the plurality of learners in real-time during the live learning session.
